(19) United States
(12) Patent Application Publication
(10) Pub. No.: US 2016/0334038 A1
(43) Pub. Date: Nov. 17, 2016

(54) ADAPTER FOR DRAINAGE HOLE

(71) Applicant: Yu-Feng Yang, Taichung City (TW)

(72) Inventor: Yu-Feng Yang, Taichung City (TW)

(21) Appl. No.: 15/092,617

(22) Filed: Apr. 7, 2016

(30) Foreign Application Priority Data
May 12, 2015 (TW) 104207227

(51) Int. Cl. F16L 25/00; F16L 41/08

(52) U.S. Cl. CPC F16L 25/009; F16L 41/086

(57) ABSTRACT

An adapter for drainage hole includes a main body having at least one opening defined in a top portion thereof, wherein the main body is a tubular structure. The adapter includes a converging structure radially extending from a lower portion of the main body, wherein multiple converging holes are defined in the converging structure. A fixing structure longitudinally extends from the lower portion of the main body and is adapted to be secured on a filter that is secured in the drainage hole. The converging structure is skirt-shaped and the converging hole is arched-shaped. The fixing structure includes multiple insertions that extend through the filter and extend into the drainage hole for holding the main body in place.

### BACKGROUND OF THE INVENTION

1. Field of the Invention

The present invention relates to an adapter, and more particularly to an adapter for drainage hole.

2. Description of Related Art

Nowadays, many buildings only focus on their Architecture and outward appearance design, but ignore some details for dweller's daily life such that some problem will be happened. For example, whatever a villa or building, the drainage pipeline is hard to be changed when the building is completely finished. As a result, the living space and the home appliances cannot be effectively arranged, such as the refrigerator in the kitchen, the washing machine in the bathroom or the air-conditioner in the living room because they usually need a corresponding drainage hole. It will be a great problem when the drainage hole is inadequate to the home appliances that need a corresponding drainage hole. Furthermore, the water from the cistern will flow over the terrace to the drainage hole when the drain hose of the washing machine is inserted into the only one drainage hole in the terrace. As a result, the terrace may be dirty and at sixes and sevens.

The present invention has arisen to mitigate and/or obviate the disadvantages of the conventional adapter for drainage hole.

### SUMMARY OF THE INVENTION

The main objective of the present invention is to provide an improved adapter for drainage hole, wherein the adapter can be connected to drain hoses of a washing machine and a cistern such that the water from the washing and the cistern can be drained via the drainage hole in the terrace without flowing over the terrace.

To achieve the objective, the adapter in accordance with the present invention comprises a main body having at least one opening defined in a top portion thereof, wherein the main body is a tubular structure. The adapter includes a converging structure radially extending from a lower portion of the main body, wherein multiple converging holes are defined in the converging structure. A fixing structure longitudinally extends from the lower portion of the main body and is adapted to be secured on a filter that is secured in the drainage hole. The converging structure is skirt-shaped and the converging hole is arched-shaped. The fixing structure includes multiple insertions that extend through the filter and extend into the drainage hole for holding the main body in place.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adapter for drainage hole in accordance with the present invention;

FIG. 2 is a perspective view of a second embodiment of the main body of the adapter in FIG. 1;

FIG. 3 is a perspective view of a third embodiment of the main body of the adapter in FIG. 1

FIG. 4 is a cross-sectional view of a second embodiment of the adapter for drainage hole in accordance with the present invention;

FIG. 5 is an exploded perspective view of a second embodiment of the adapter for drainage hole in accordance with the present invention;

FIG. 6 is a perspective view of a second embodiment of the main body of the adapter in FIG. 5;

FIG. 7 is a perspective view of a third embodiment of the main body of the adapter in FIG. 5;

FIG. 8 is a perspective view of a fourth embodiment of the main body of the adapter in FIG. 5; and

FIG. 9 is a perspective view of a fifth embodiment of the main body of the adapter in FIG. 5;

### DETAILED DESCRIPTION OF THE INVENTION

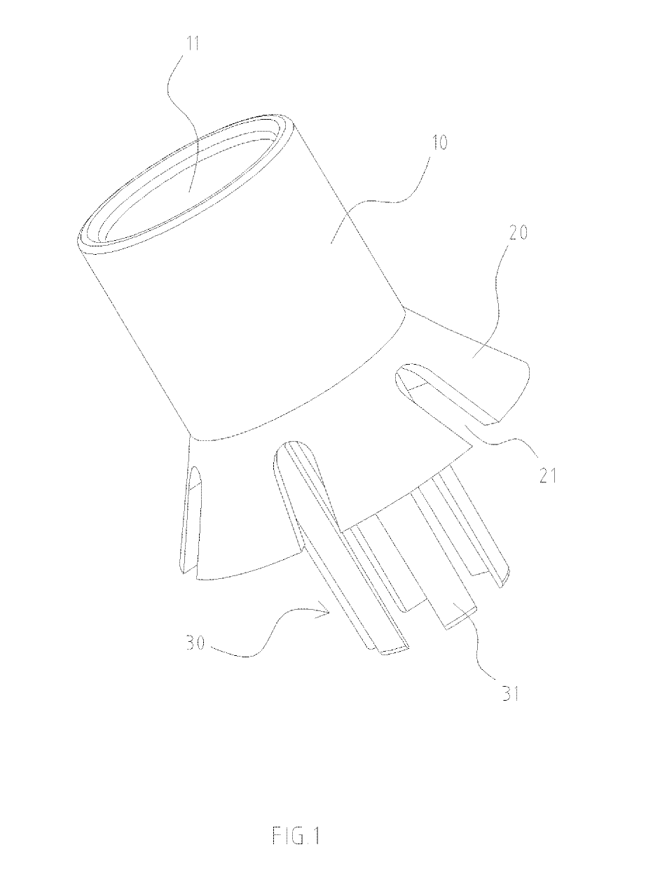

Referring to the drawings and initially to FIG. 1, a adapter for drainage hole in accordance with the present invention comprises a main body 10 having at least one opening 11 defined in a top portion thereof, wherein the main body 10 is a tubular structure. The adapter includes a converging structure 20 radially extending from a lower portion of the main body 10, wherein multiple converging holes 21 are defined in the converging structure 20. A fixing structure 30 longitudinally extends from the lower portion of the main body 10 and is adapted to be secured on a filter (not shown) that is secured in the drainage hole (not shown). The converging structure 20 is skirt-shaped and the converging hole 21 is arched-shaped. The fixing structure 30 includes multiple insertions 31 that extend through the filter and extend into the drainage hole for holding the main body 10 in place. In the preferred embodiment of the present invention, the main body 10 is a straight.

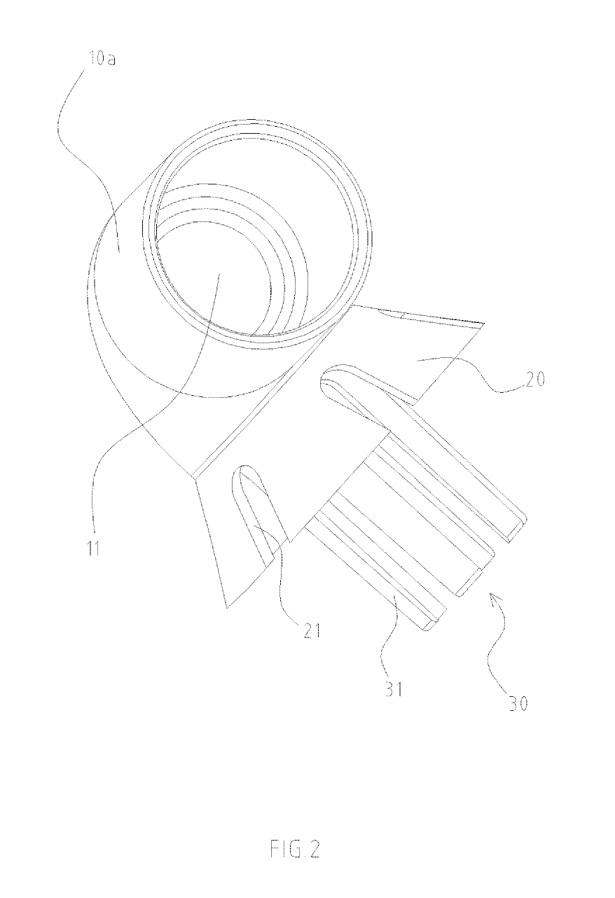

With reference to FIG. 2 that show a second embodiment of the main body 10a of the adapter as shown in FIG. 1, in this embodiment, the adapter in accordance with the present invention has an L-shaped structure and the main body 10a has an elbow structure.

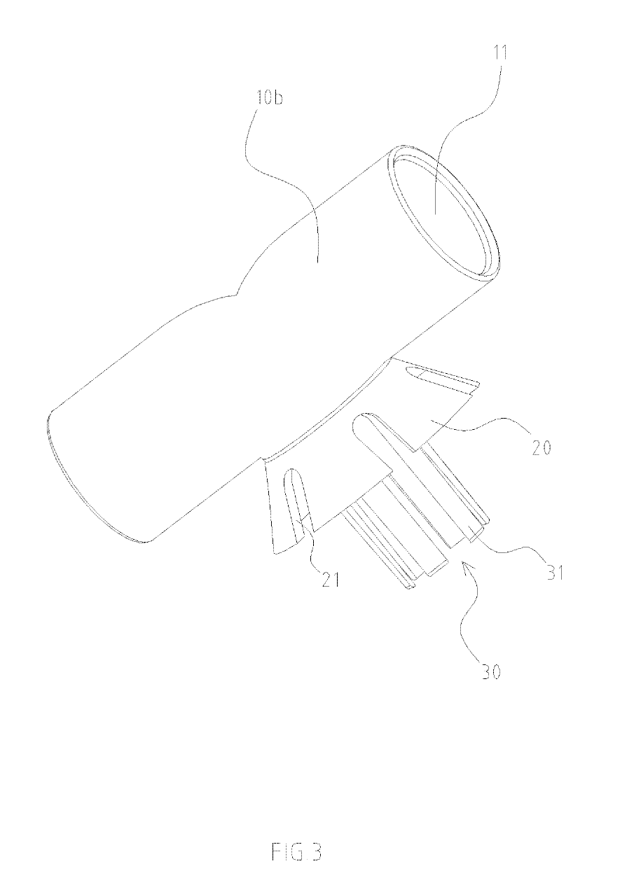

With reference to FIG. 3 that show a third embodiment of the main body 10b of the adapter as shown in FIG. 1, in this embodiment, the adapter in accordance with the present invention has a T-shaped structure and the main body 10b is transverse relative to the fixing structure 30, wherein the main body 10b has two openings 11 defined therein and the two openings 11 longitudinally communicate with each other.

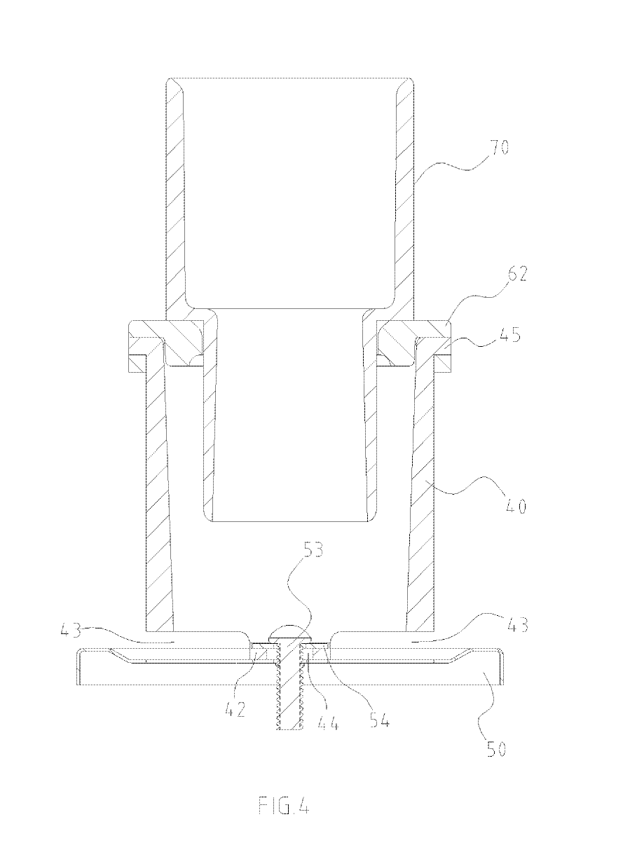

With reference to FIGS. 4 and 5 that show a second embodiment of the adapter for drainage hole in accordance with the present invention, in this embodiment, the adapter includes a main body 40, wherein the main body 40 is hollow. The main body 40 has at least one opening 41 defined in a top thereof and at least one separators 42 transversely from a bottom of the main body 40 to defined at least two converging holes 43. A first through hole 44 is centrally defined in the separator 42 at least one separator 42. The main body 40 has at least two stubs 45 radially extending from the top thereof.

A pad 50 is secured onto the at least one separator 42. A second through hole 51 is centrally defined in the pad 50 and communicating with the first through hole 44 when the pad 50 is mounted to the main body 40. At least two drain holes 52 is defined in the pad 50, wherein each drain hole 52 communicate with a corresponding one of the at least two converging holes 43 in the main body 40. A bolt 53 sequentially extends through the first through hole 44 and the second through hole 51, and screwed into the filter (not shown) that is secured in the drainage hole (not shown) for holding the main body 40 and the pad 50 in place wherein a washer 54 is disposed between the bolt 53 and the at least one separator 42.

A coupling 60 is mounted onto the top of the main body 40 and has a through hole 61 centrally defined therein. The coupling 60 has at least two engagers 62 radially formed thereon, wherein each engager 62 is selectively engaged to a corresponding one of the at least two stubs 45 for holding the coupling 60 in place on the main body 40. A tubular connector 70 extends through the coupling 60 and is inserted into the main body 40 through the opening 41 for connecting to a drain hose (not shown).

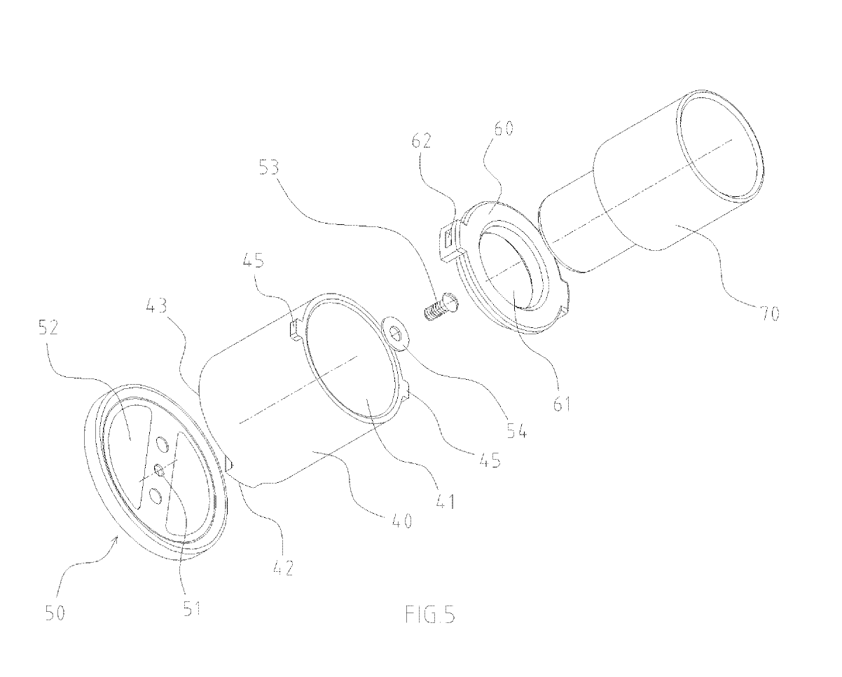

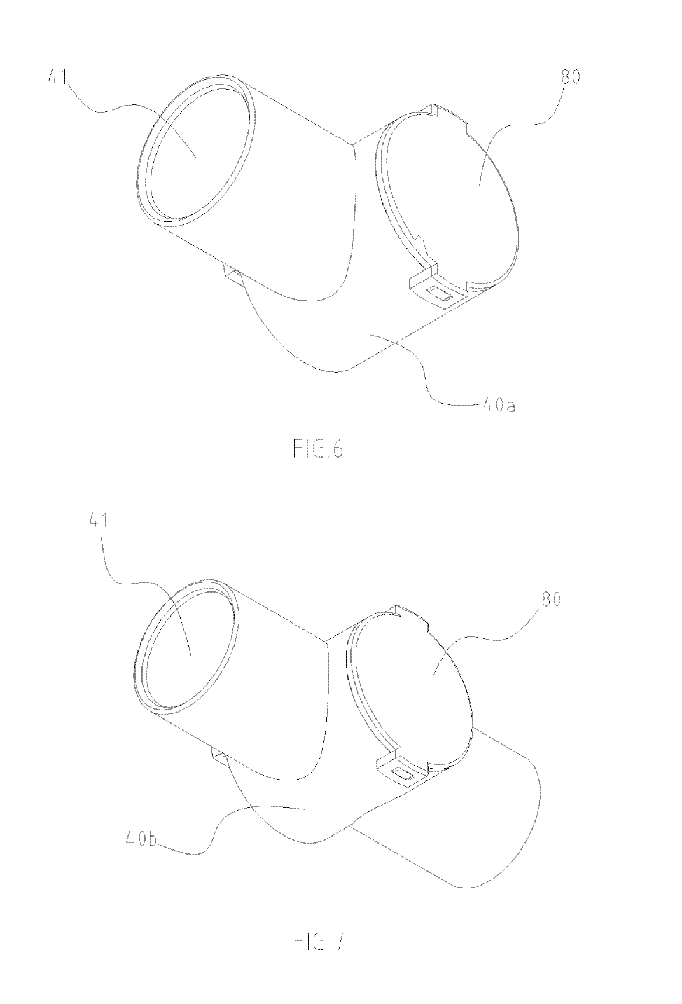

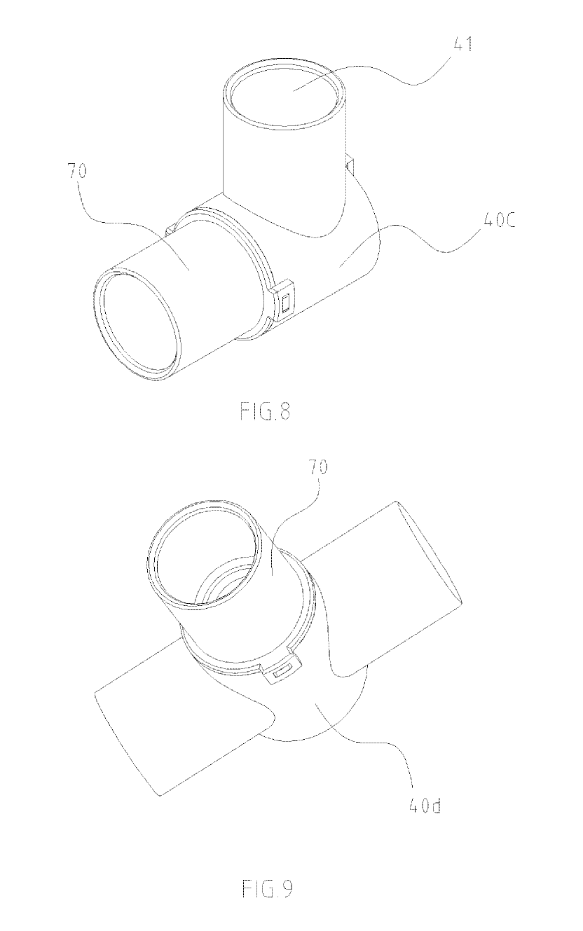

With reference to FIG. 6 that shows a second embodiment of the main body 40a of the adapter as shown in FIG. 5, in this embodiment, the main body 40a is L-shaped and has two openings 41 defined therein, wherein a closing element 80 is provided to seal an idle opening With reference to FIG. 7 that shows a third embodiment of the main body 40b of the adapter as shown in FIG. 5, in this embodiment, the main body 40b is cross-shaped and has three openings defined therein, wherein a closing element 80 is provided to seal an idle opening With reference to FIG. 8 that shows a fourth embodiment of the main body 40c of the adapter as shown in FIG. 5, in this embodiment, the main body 40c is L-shaped and has two openings defined therein. With reference to FIG. 9 that shows a fifth embodiment of the main body 40d of the adapter as shown in FIG. 5, in this embodiment, the main body 40d is L-shaped and has three openings defined therein.

As described above, the adapter for drainage hole in accordance with the present invention is mounted on a filter secured in the drainage hole can drain the water via the converging holes. For example, when the adapter of the present invention is used on a terrace, the tubular connectors 70 can be connected to drain hoses of a washing machine and a cistern such that the water from the washing and the cistern can be drained via the drainage hole in the terrace without flowing over the terrace. In addition, the tubular connector 70 on the present invention can be replaced for hoses that have different standards.

Although the invention has been explained in relation to its preferred embodiment, it is to be understood that many other possible modifications and variations can be made without departing from the spirit and scope of the invention as hereinafter claimed.

What is claimed is:

1. An adapter for drainage hole, comprising:
a main body having at least one opening defined in a top portion thereof, wherein the main body is a tubular structure;
a converging structure radially extending from a lower portion of the main body, wherein multiple converging holes are defined in the converging structure; and
a fixing structure longitudinally extending from the lower portion of the main body and adapted to be secured on a filter that is secured in the drainage hole.

2. The adapter as claimed in claim 1, wherein the converging structure is skirt-shaped.

3. The adapter as claimed in claim 1, wherein the fixing structure includes multiple insertions that extend through the filter and extend into the drainage hole for holding the main body in place.

4. The adapter as claimed in claim 1, wherein the converging holes are arched-shaped.

5. The adapter as claimed in claim 1, wherein the main body has one opening laterally defined therein such that the main body is L-shaped.

6. The adapter as claimed in claim 1, wherein the main body has two openings respectively laterally defined therein and co-axially communicating with each other such that the main body is T-shaped.

7. An adapter for drainage hole, comprising:
a main body, wherein the main body is hollow, the main body having at least one opening defined in a top thereof and at least one separators transversely from a bottom of the main body to defined at least two converging holes, a first through hole centrally defined in the separator at least one separator; and
a bolt extending through the first through hole and screwed into the filter that is secured in the drainage hole for holding the main body.

8. The adapter as claimed in claim 7 further comprising a pad secured onto the at least one separator, a second through hole centrally defined in the pad and communicating with the first through hole when the pad is mounted to the main body, wherein the bolt sequentially extending through the first through hole and the second through hole, at least two drain holes defined in the pad, wherein each drain hole communicates with a corresponding one of the at least two converging holes in the main body.

9. The adapter as claimed in claim 7, wherein the main body has at least two stubs radially extending from the top thereof.

10. The adapter as claimed in claim 9 further comprising a coupling mounted onto the top of the main body and having a through hole centrally defined therein, the coupling having at least two engagers radially formed thereon, wherein each engager is selectively engaged to a corresponding one of the at least two stubs for holding the coupling in place on the main body.

11. The adapter as claimed in claim 10 further comprising a tubular connector extending through the coupling and is inserted into the main body through the opening for connecting to a drain hose.
